(19) United States
(12) Patent Application Publication
(10) Pub. No.: US 2011/0140638 A1
(43) Pub. Date: Jun. 16, 2011

(54) Socket Extension Apparatus, Socket Adapter, and Plug Adapter

(75) Inventor: Robert Frazzini, Wexford, PA (US)

(73) Assignee: Still Dreaming LLC, Wexford, PA (US)

(21) Appl. No.: 12/637,275

(22) Filed: Dec. 14, 2009

(51) Int. Cl. H05B 37/00; H01R 13/56; H01R 27/02; F21V 7/00; F21V 15/00

(52) U.S. Cl. 315/313; 439/445; 439/638; 362/235; 362/234; 315/312

(57) ABSTRACT

A socket extension apparatus, including: an elongate extension member having a first end and a second end; and at least one socket member in operational communication with the second end of the extension member and in direct or indirect electrical communication with an external power source through the first end of the extension member, the at least one socket member comprising at least one socket recess configured to removably engage at least one light bulb. A socket adapter and a plug adapter are also provided.

### BACKGROUND OF THE INVENTION

1. Field of the Invention

The present invention relates generally to lighting arrangements, lighting systems, electrical fixtures, sockets, socket arrangements, and the like, and in particular to a socket extension apparatus, socket adapter, and plug adapter for use in connection with lighting arrangements and installations.

2. Description of the Related Art

In the field of lighting arrangements and fixtures, the general goal is to provide light to desired areas by activating the lighting arrangement or appliance, such as a lamp, overhead light, desktop lighting device, outdoor spotlight arrangement, and the like. There exist thousands of variations in such lighting devices and system, and such devices and systems are used throughout the world.

Accordingly, and as is well known, a lighting arrangement includes a socket with at least one recess therein configured to accept a portion of a light bulb. For example, a traditional incandescent light bulb includes a threaded socket projection that is in threaded engagement with a central socket recess in a traditional socket member. Neon and other light emitting structures also normally include a bulb with multiple projecting members that can be aligned with and removably inserted within recesses (or orifices) in a matching socket member. The socket member is normally formed as part of the body of the lamp or directly wired into a fixture in the wall of a structure. In this manner, when the bulb and the socket are engaged, electrical communication is achieved, and the light bulb is activated or powered.

One drawback to traditional lighting arrangements is the inability to effectively adjust the light to appropriately illuminate a specified position. For example, when a person desires to illuminate a different location, he or she would need to physically move the (often heavy or cumbersome) lamp, change the angle of the lamp shade, or otherwise force the lighting arrangement into the appropriate orientation. In an attempt to address this problem, certain appliances and lighting arrangement have been developed. For example, U.S. Pat. No. 6,874,908 discloses a flexible bendable flashlight, U.S. Pat. No. 6,540,184 discloses a flexible leg flashlight holder, and U.S. Pat. No. 6,304,712 discloses a bendable illuminating appliance. However, such devices and arrangements are not wholly configurable, require complex connections, and/or require additional supportive structure, including, for example, a battery-derived power source. Using batteries in connection with normal, often used lighting arrangements and systems is impractical and expensive.

Accordingly, there remains considerable room in the art for improvements in the field of lighting arrangements, electrical fixtures, and the like. For example, there is a need in the art for a socket extension apparatus, socket adapter, and plug adapter that address some or all of the deficiencies associated with prior art lighting arrangements.

### SUMMARY OF THE INVENTION

Generally, the present invention provides a socket extension apparatus, socket adapter, and plug adapter that addresses some or all of the deficiencies and drawbacks associated with prior art lighting arrangements and systems. In some embodiments, the present invention provides a socket extension apparatus that is configurable and attachable to some power source. In other embodiments, the present invention provides a socket extension apparatus that is removably engageable with a plug outlet or a socket fixture. In further embodiments, the present invention provides a socket adapter and a plug adapter that facilitate the conversion between a plug and a socket.

Accordingly, and in one preferred and non-limiting embodiment, the present invention is directed to a socket extension apparatus, including: an elongate extension member having a first end and a second end; and at least one socket member in operational communication with the second end of the extension member and in direct or indirect electrical communication with an external power source through the first end of the extension member. The at least one socket member includes at least one socket recess configured to removably engage at least one light bulb.

In another preferred and non-limiting embodiment, the present invention is directed to a socket adapter, including: a body with a first end and a second end; a socket projection at the first end of the body and configured for removable attachment with a socket recess; two aligned slots at the second end of the body configured to receive two power prongs of a three-prong plug member; and a lower slot at the second end of the body configured to receive a ground prong of the three-prong plug member.

In a further preferred and non-limiting embodiment, the present invention is directed to a plug adapter, including: a body with a first end and a second end; at least two prongs at the first end of the body configured for insertion into at least two slots of an electrical outlet; and a socket recess at the second end of the body configured to removably engage at least one light bulb.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic view of one embodiment of a socket extension apparatus according to the principles of the present invention;

FIG. 2 is a schematic view of one embodiment of a socket adapter according to the principles of the present invention;

FIG. 3 is a schematic view of one embodiment of a plug adapter according to the principles of the present invention;

FIG. 4 is a perspective view of one embodiment of a socket extension apparatus according to the principles of the present invention;

FIG. 5 is a perspective view of another embodiment of a socket extension apparatus according to the principles of the present invention;

FIG. 6 is a perspective view of a further embodiment of a socket extension apparatus according to the principles of the present invention;

FIGS. 7(a)-(b) are views of a portion of the socket extension apparatus of FIG. 4;

FIGS. 8(a)-(b) are exploded, perspective views of the socket extension apparatus of FIG. 4;

FIGS. 9(a)-(b) are exploded, perspective views of a portion of the socket extension apparatus of FIG. 4;

FIGS. 10(a)-(b) are exploded, perspective views of another portion of the socket extension apparatus of FIG. 4;

FIG. 11 is a plan view of another embodiment of a socket extension apparatus according to the principles of the present invention;

FIGS. 12(a)-(b) are exploded, perspective views of the socket extension apparatus of FIG. 11;

FIGS. 13(a)-(b) are exploded, perspective views of a portion of the socket extension apparatus of FIG. 11;

FIGS. 14(a)-(b) are exploded, perspective views of another portion of the socket extension apparatus of FIG. 11;

FIG. 15 is a plan view of a further embodiment of a socket extension apparatus according to the principles of the present invention;

FIGS. 16(a)-(b) are exploded, perspective views of the socket extension apparatus of FIG. 15;

FIGS. 17(a)-(b) are exploded, perspective views of a portion of the socket extension apparatus of FIG. 15;

FIGS. 18(a)-(b) are exploded, perspective views of another portion of the socket extension apparatus of FIG. 15;

FIG. 19 is a plan view of another embodiment of a socket extension apparatus according to the principles of the present invention;

FIG. 20 is an exploded, perspective view of the socket extension apparatus of FIG. 19;

FIG. 21 is an exploded, perspective view of a portion of the socket extension apparatus of FIG. 19;

FIG. 22 is an exploded, perspective view of another portion of the socket extension apparatus of FIG. 19;

FIG. 23 is an exploded, perspective view of another portion of the socket extension apparatus of FIG. 19;

FIG. 24 is a plan view of a further embodiment of a socket extension apparatus according to the principles of the present invention;

FIG. 25 is an exploded, perspective view of the socket extension apparatus of FIG. 24;

FIG. 26 is an exploded, perspective view of a portion of the socket extension apparatus of FIG. 24;

FIG. 27 is an exploded, perspective view of another portion of the socket extension apparatus of FIG. 24;

FIG. 28 is an exploded, perspective view of another portion of the socket extension apparatus of FIG. 24;

FIG. 29 is a plan view of another embodiment of a socket extension apparatus according to the principles of the present invention;

FIG. 30 is an exploded, perspective view of the socket extension apparatus of FIG. 29;

FIG. 31 is an exploded, perspective view of a portion of the socket extension apparatus of FIG. 29;

FIG. 32 is an exploded, perspective view of another portion of the socket extension apparatus of FIG. 29;

FIG. 33 is an exploded, perspective view of another portion of the socket extension apparatus of FIG. 29;

FIGS. 34(a)-(b) are views of another embodiment of a socket extension apparatus according to the principles of the present invention;

FIGS. 35(a)-(c) are view of a portion of a further embodiment of a socket extension apparatus according to the principles of the present invention;

FIGS. 36(a)-(c) are view of a portion of another embodiment of a socket extension apparatus according to the principles of the present invention; and

FIG. 37 is a perspective view of a still further embodiment of a socket extension apparatus according to the principles of the present invention.

### DETAILED DESCRIPTION OF THE PREFERRED EMBODIMENTS

For purposes of the description hereinafter, the terms “end”, “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting. Further, it is to be understood that the invention may assume various alternative variations and step sequences, except where expressly specified to the contrary.

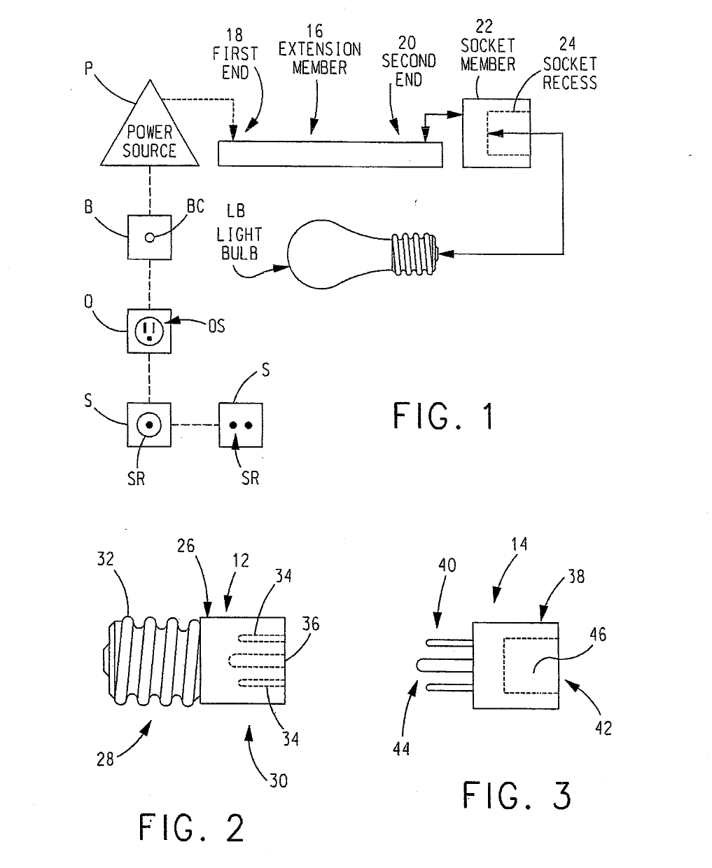

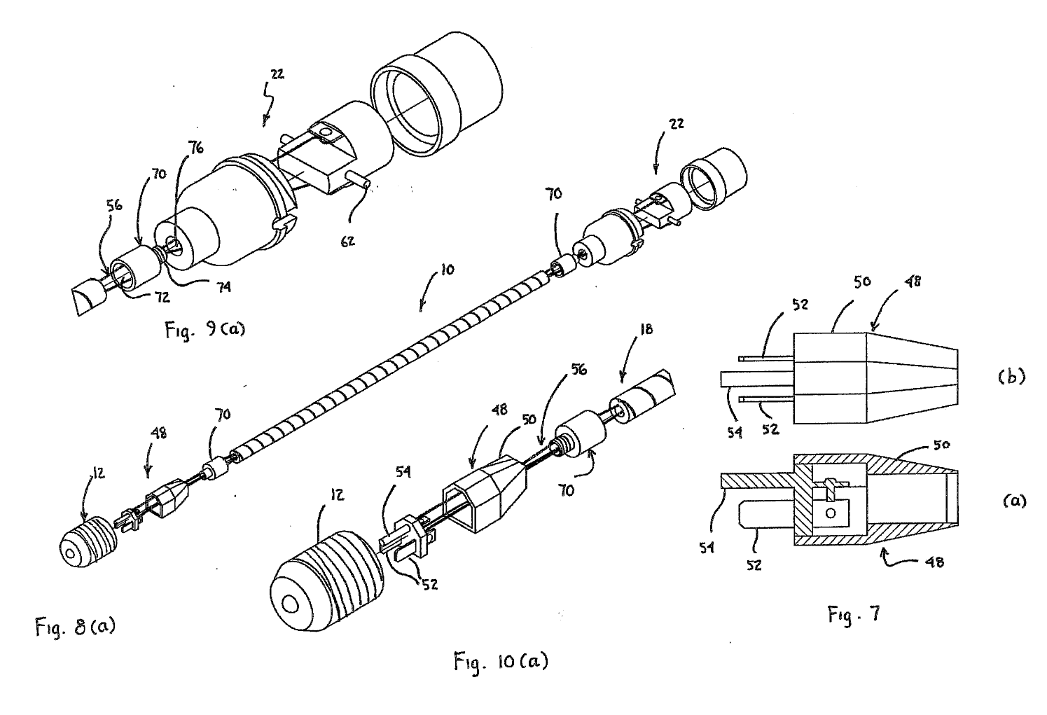

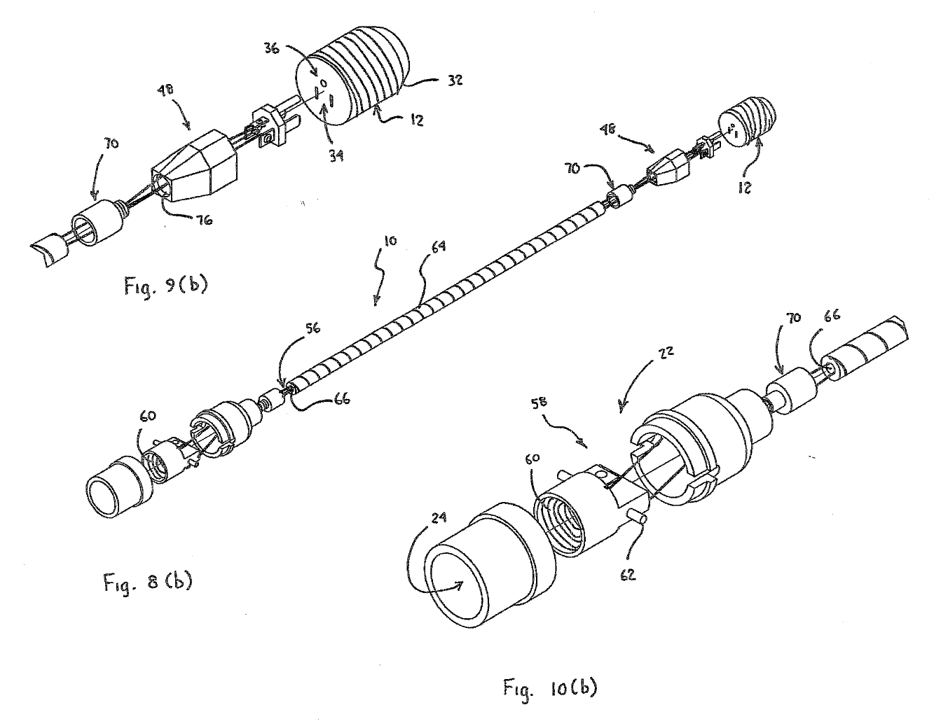

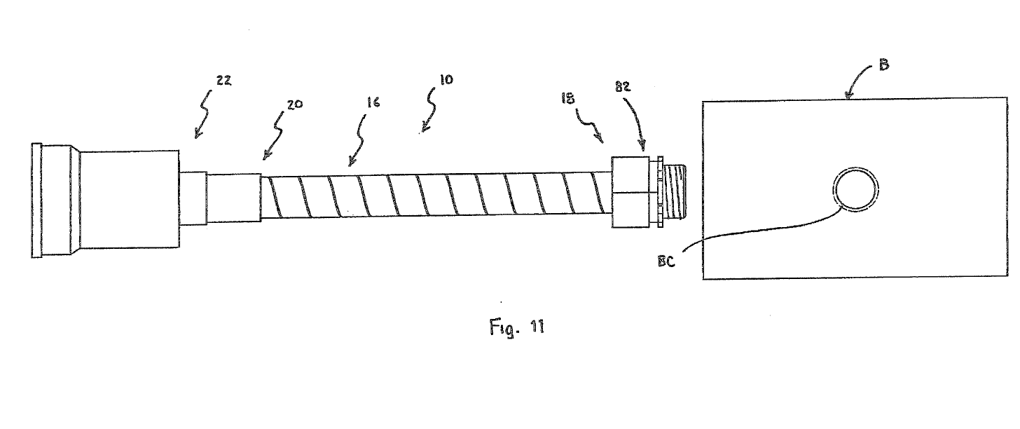

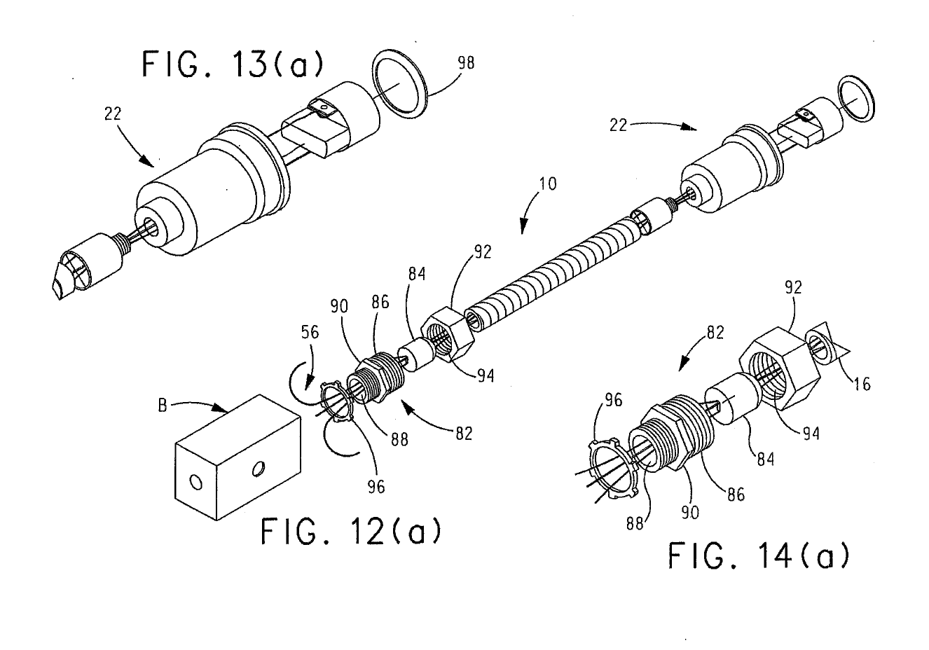

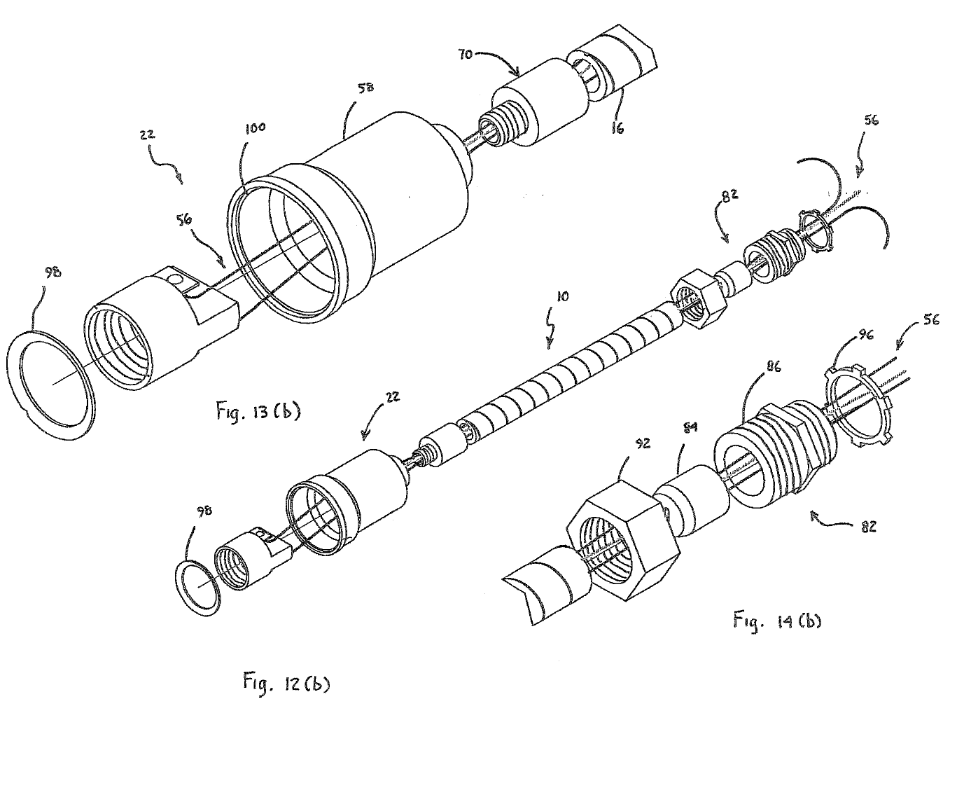

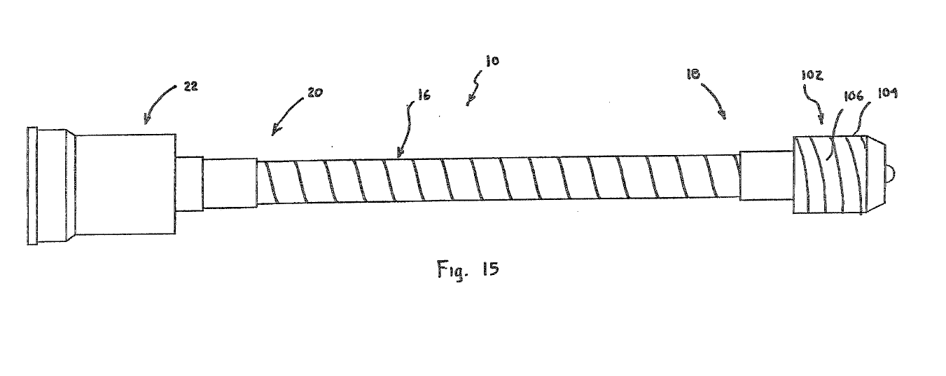

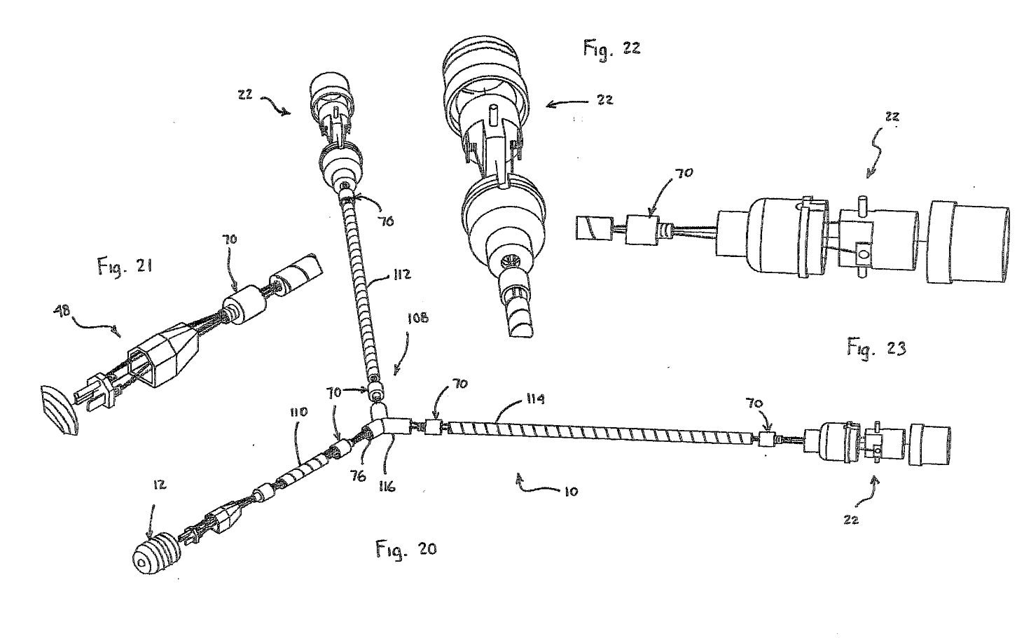

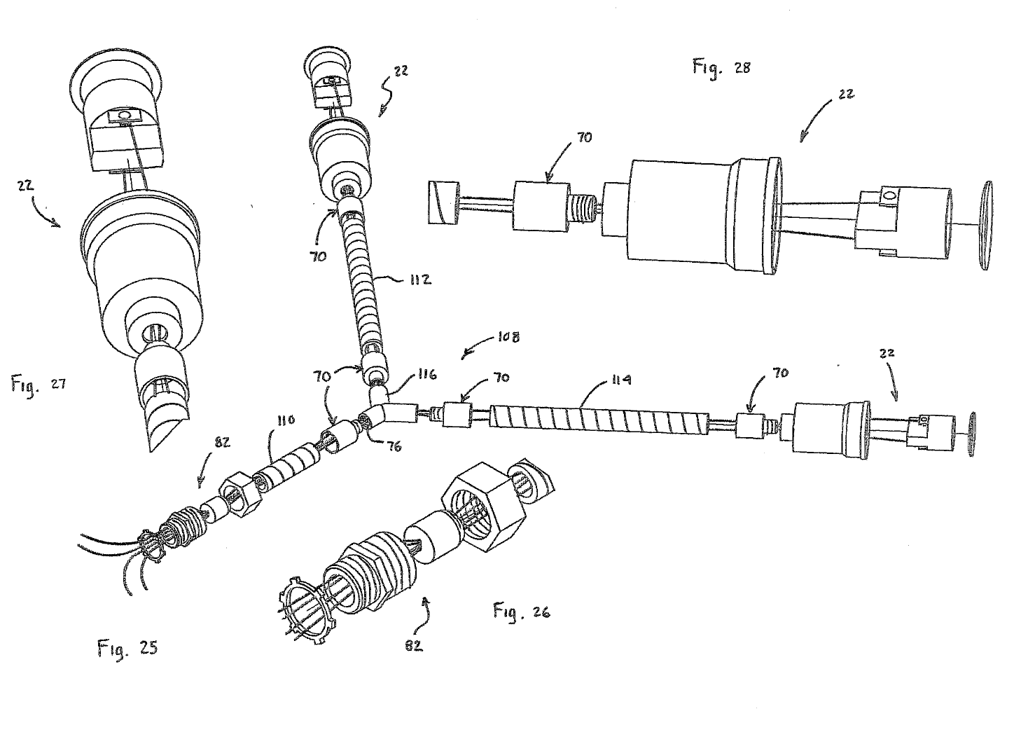

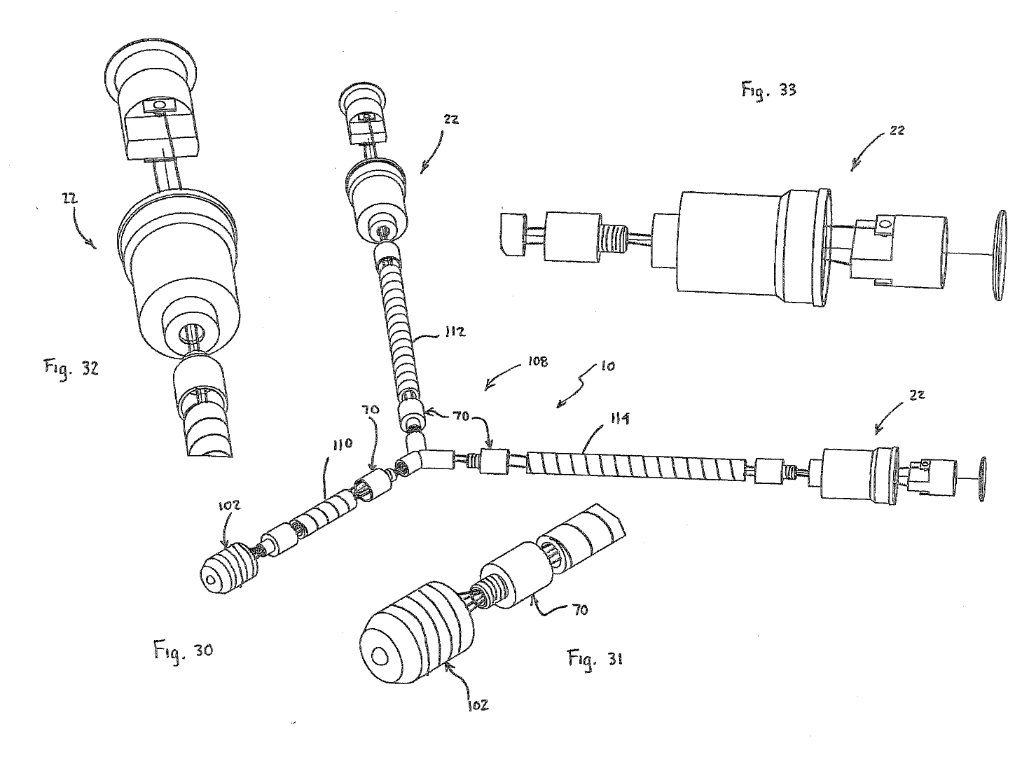

The present invention is directed to a socket extension apparatus 10, socket adapter 12, and plug adapter 14. Various preferred and non-limiting embodiments of the socket extension apparatus 10, socket adapter 12, and plug adapter 14 are illustrated in FIGS. 1-37. Further, the socket extension apparatus 10 is useful in connection with and derives electricity from some external power source P. This external power source P can take a variety of forms, including an electrical box B, an electrical outlet O, and a socket S. However, it is envisioned that any external power source P can be used in connection with the socket extension apparatus 10, socket adapter 12, and plug adapter 14 of the present invention.

When the power source P is an electrical box B, and as illustrated in FIG. 1, this electrical box B includes a box connection BC, typically in the form of a threaded orifice. Some appliance can be connected and directly wired into the electrical box B through this box connection BC (which is retaining the structure wiring and other electrical components).

When used in connection with an electrical outlet O, and as is well known, this outlet O includes multiple plug slots OS. These plug slots OS are specifically configured to receive an arrangement of plug prongs therein. For example, two plug slots OS may be provided to engage with two prongs, and three plug slots OS may be provided to engage with three prongs, where one of the prongs is a ground prong.

With reference to the socket recess SR, this power source P may also include differing arrangements and numbers of recesses SR. For example, a single threaded recess can be provided to accept a single socket projection (i.e., male portion) of a known incandescent light bulb LB. However, multiple recesses SR or arrangements can be used to connect with and supply power to different connections and/or projections on different types of light bulbs LB, such as a neon bulb, or other light bulb LB including multiple projections for making electrical connection. Further, it is envisioned that the light bulb LB may be in the form a variety of different light sources, such as light emitting diodes (LEDs) and the like. Accordingly, it is envisioned that the present invention is useful in connection with a variety of different power sources P and light bulbs LB.

With continued reference to FIG. 1, and in one preferred and non-limiting embodiment, the socket extension apparatus 10 includes an elongate extension member 16, and this extension member 16 includes a first end 18 and a second end 20. Further, the socket extension apparatus 10 of this embodiment includes a socket member 22 in operational communication with the second end 20 of the extension member 16, and this socket member 22 is in direct or indirect electrical communication with the power source P through the first end 18 of the extension member 16. Further, the socket member 22 includes one or more socket recesses 24 configured to removably engage with at least one light bulb LB. As discussed above, any number of or configuration of socket recesses 24 are envisioned within the context of the present invention, and for use in removably engaging with a variety of different types of light bulbs LB.

As seen in FIG. 2, one preferred and non-limiting embodiment of a socket adapter 12 is provided. This socket adapter 12 includes a body 26 with a first end 28 and a second end 30. A socket projection 32 is located at the first end 28 of the body 26 and allows for removable attachment with a socket recess SR. Two aligned slots 34 are positioned at the second end 30 of the body 26 for receiving two power prongs of a three-prong plug member. Further, a lower slot 36 is also provided at the second end 30 of the body 26 for receiving a ground prong of the three-prong plug member. Accordingly, while the socket adapter 12 is useful in connection with certain embodiments of the socket extension apparatus 10, it is equally useful as a standalone component for converting between a plug and a socket S. In addition, the number, size, and configuration of the slots 34, 36 may be modified to accommodate any number, size, or configuration of male portions, extension members, prongs, or other structural arrangements for making an electrical connection.

In another aspect of the present invention, and in one preferred and non-limiting embodiment as shown in FIG. 3, a plug adapter 14 includes a body 38 with a first end 40 and a second end 42. At least two prongs 44 are located at and extend from the first end 40 of the body 38 and are sized and shaped for insertion into the plug slots OS of an electrical outlet O. In addition, the plug adapter 14 includes a socket recess 46 positioned at the second end 42 of the body 38 for removably engaging with the male portion or socket projection of a light bulb LB. As with the socket adapter 12, the plug adapter 14 is useful in connection with socket extension apparatus 10, and further useful as a standalone component for converting between a socket projection and an electrical outlet O. In addition, and as with the socket adapter 12, the plug adapter 14 may include any number, size, or configuration of male portions, extension members, prongs 44, or other structural arrangements for making an electrical connection with an outlet (or power source P).

Accordingly, the socket adapter 12 allows for the transfer and conversion of power from a socket recess SR through the socket projection 32 and the slots 34. This, in turn, allows an electrical appliance to draw power from a socket S using a well-known plug member. Similarly, the plug adapter 14 allows for the conversion between an electrical outlet O and a light bulb LB having one or more socket projections (as discussed above). Therefore, the plug adapter 14 allows for the use of a known electrical outlet O to provide power directly to a light bulb LB or other appliance having a socket projection.

In one preferred and non-limiting embodiment, as illustrated in FIGS. 4 and 7-10, a plug member 48 is positioned at the first end 18 of the extension member 16, and this plug member 48 includes a body 50 with two aligned power prongs 52 and a ground prong 54. This plug member 48 provides power to the second end 20 of the extension member 16, at which the socket member 22 is provided. In particular, the power is communicated (and the grounding effected) through known wiring 56 configurations. In particular, the power prongs 52 and ground prong 54 are electrically connected through this wiring 56 to a portion of the socket member 22. Again, while a three-wire (grounded) wiring 56 arrangement is illustrated, a two-wire (ungrounded) wiring 56 arrangement is likewise envisioned. Accordingly, the attachments between the electrical contacts may be a single prong, a two-prong, a three-prong, or any other mating electrical relationship.

As also illustrated in this embodiment, the socket member 22 includes the socket recess 24 extending into a socket body 58. Further, the socket recess 24 includes threads 60 on at least a portion of an inner surface of the socket recess 24, and these threads 60 are sized and shaped so as to threadedly engage with a portion (the socket projection portion) of a light bulb LB. Additionally, a switch 62 is in electrical communication with a portion of the socket member 22 and extends through or is at least partially engaged with the body 58, and this switch 62 allows the power to be turned “on” and “off” with respect to the socket member 22 (thereby allowing the light bulb LB to be activated and deactivated). While the switch 62 illustrated in FIGS. 4, 8, and 9 is a push-actuated switch, any number and types of switches are envisioned, such as a rocker switch, a turn-actuated switch, and the like.

Still further, and in this preferred and non-limiting embodiment, the socket adapter 12 is used and removably connectable to the plug member 48. This allows the user to provide electricity to the socket extension apparatus 10 either directly through the plug member 48 (as plugged into an electrical outlet O) or through a socket S (using the socket adapter 12).

As also illustrated in this embodiment, the extension member 16 is in the form of a ribbed tube 64 with a hollow interior 66. By using this ribbed tube 64, the extension member 16 is bendable in various directions and into a configurable position. In addition, by using such a ribbed tube 64, the extension member 16 can remain in this bent position until further manipulated. Of course, any number of such arrangements and structures can be used to allow the extension member 16 to be manipulated and bent, such as multiple, engaged parts or pieces, such as tubular lengths, sleeve members, interlinking members, and the like.

As also illustrated in the embodiment of FIGS. 4 and 7-9, and in order to attach the plug member 48 to the first end 18 of the extension member 16 and the socket body 58 to the second end 20 of extension member 16, a nipple member 70 can be used on each end 18, 20. In particular, this nipple member 70 may include a recess 72 on one end and a projection 74 on the other end. The recess 72 could be fitted over and either crimped, threadedly engaged with, frictionally engaged with, etc. the ends 18, 20 of the extension member 16. Further, the projection 74 could be fitted at least partially within a nipple recess 76 extending within the body 50 of the plug member 48 or socket body 58. In one embodiment, this nipple projection 74 is threaded, such that it can be removably engaged with the nipple recess 76 (which may also be at least partially threaded on an inner surface thereof). Of course, any other type of permanent, semi-permanent, or removable arrangement can be used.

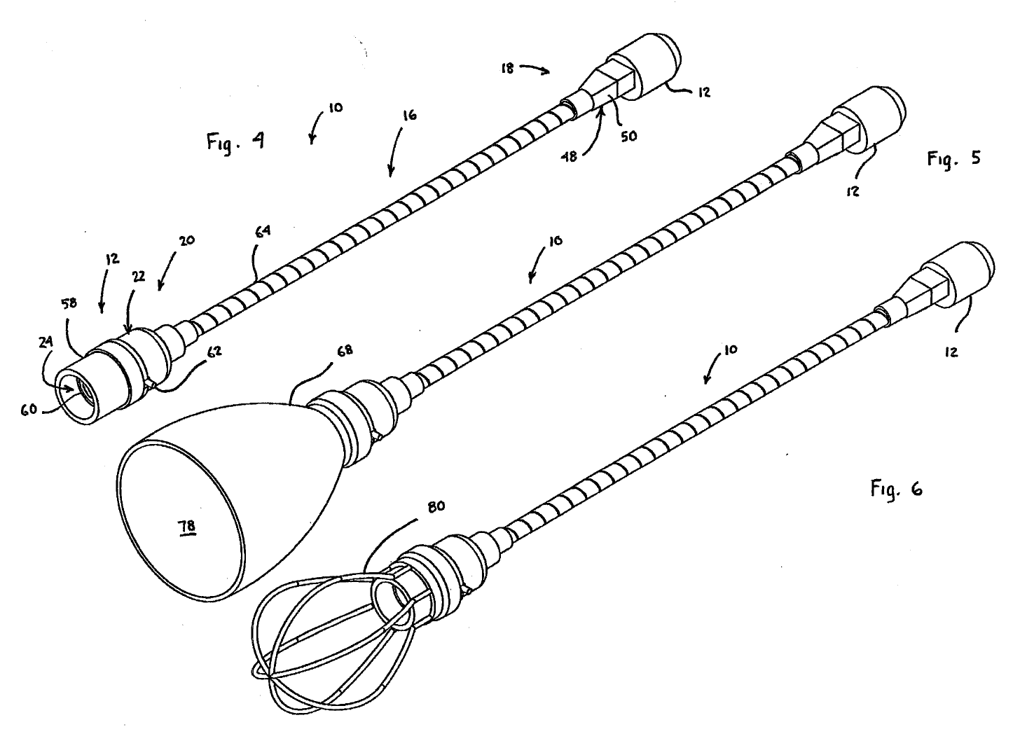

In another embodiment, and as illustrated in FIG. 5, a reflective member 68 is provided. This reflective member 68 is attachable to the second end 20 of the extension member 16 and/or the socket body 58. This attachment can be a threaded engagement, a pressure fit, a friction fit, a permanent attachment arrangement, or the like. This reflective member 68 includes an internal surface 78 that is formed or coated to assist in reflecting light emitted from the light bulb LB. In addition, this reflective member 68 acts as a shade and otherwise provides protection to the fragile light bulb LB.

In another embodiment, and as illustrated in FIG. 6, the socket extension apparatus 10 may also include a guard member 80. This guard member 80 at least partially surrounds the light bulb LB attached to the socket recess 24, and protects the light bulb LB from impact. As with the reflective member 68, the guard member 80 may be attached to a second end 20 of extension member 16 and/or the socket body 58 in a permanent, semi-permanent, removable, etc., manner. Of course, it is envisioned that both the reflective member 68 and guard member 80 can be formed with or attachable to any component or part of the socket body 58 and extension member 16.

FIGS. 11-14 are directed to a further preferred and non-limiting embodiment of the present invention. This embodiment includes the socket member 22 on the second end 20 of the extension member 16. However, the first end 18 of the extension member 16 includes a power connection arrangement 82. This power connection arrangement 82 includes multiple pieces for attaching and directly wiring the socket extension apparatus 20 into an electrical box B having a box connection BC. In this embodiment, the power connection arrangement 82 includes a flexible conduit 84 through which the wiring 56 extends, and which is engageable on or within the hollow interior 66 at the first end 18 of the extension member 16. Further, this flexible conduit 84 extends at least partially into a threaded conduit 86 having a threaded outer surface and an internal bore 88. In addition, this threaded conduit 86 includes a stop projection 90. A nut 92 includes a threaded internal bore 94 and is threadably engageable with the threaded conduit 86. In addition, a washer 96, e.g., a locking washer, is provided and positionable over the threaded conduit 86 to bear against the stop projection 90.

In assembly, the wiring 56 is electrically connected with the wiring in the electrical box B through the box connection BC. Next, the threaded conduit 86 is threadedly engaged with the box connection BC, and the remaining connections and components fitted together as illustrated in FIG. 14. This power connection arrangement 82 provides a removable, yet secure and insulated, connection between the extension member 16 and the electrical box B. The flexible conduit 84 is used to protect the wiring 56 and hollow interior 66 of the extension member 16, and the nut 92, the threaded conduit 86, and the washer 96, are used to secure the socket extension apparatus 10 to the electrical box B.

As also illustrated in this preferred and non-limiting embodiment, a gasket 98 is used and urged against a rim (or ridge) 100 of the socket body 58. As with the flexible conduit 84, this gasket 98 provides a weather-resistant fitting between the light bulb LB and the socket member 22. This makes the socket extension apparatus 10 of this embodiment particularly useful in connection with outdoor environments, which are subject to varying weather conditions.

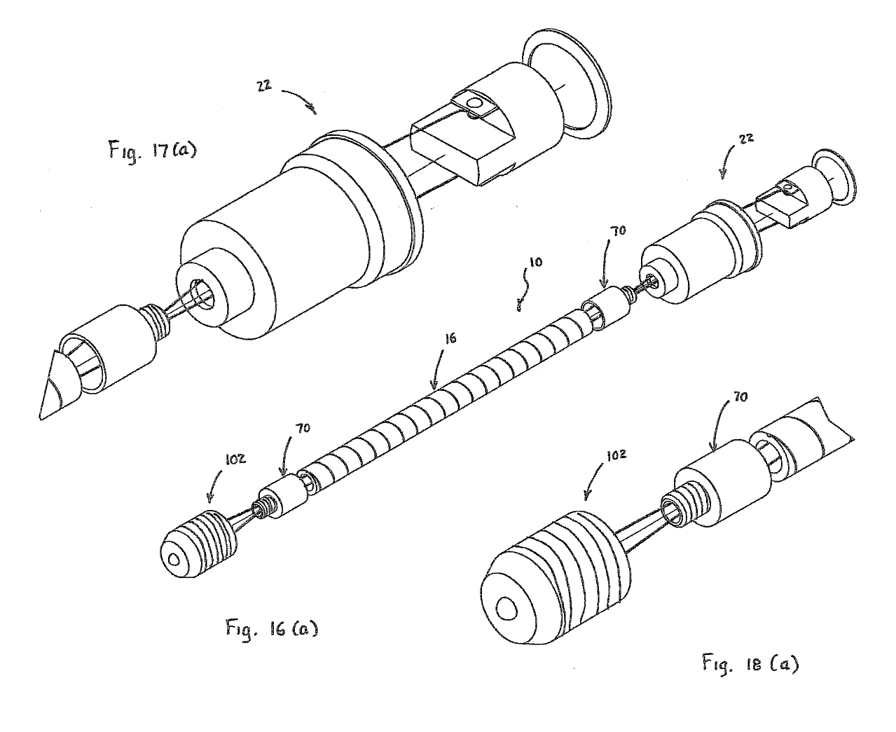

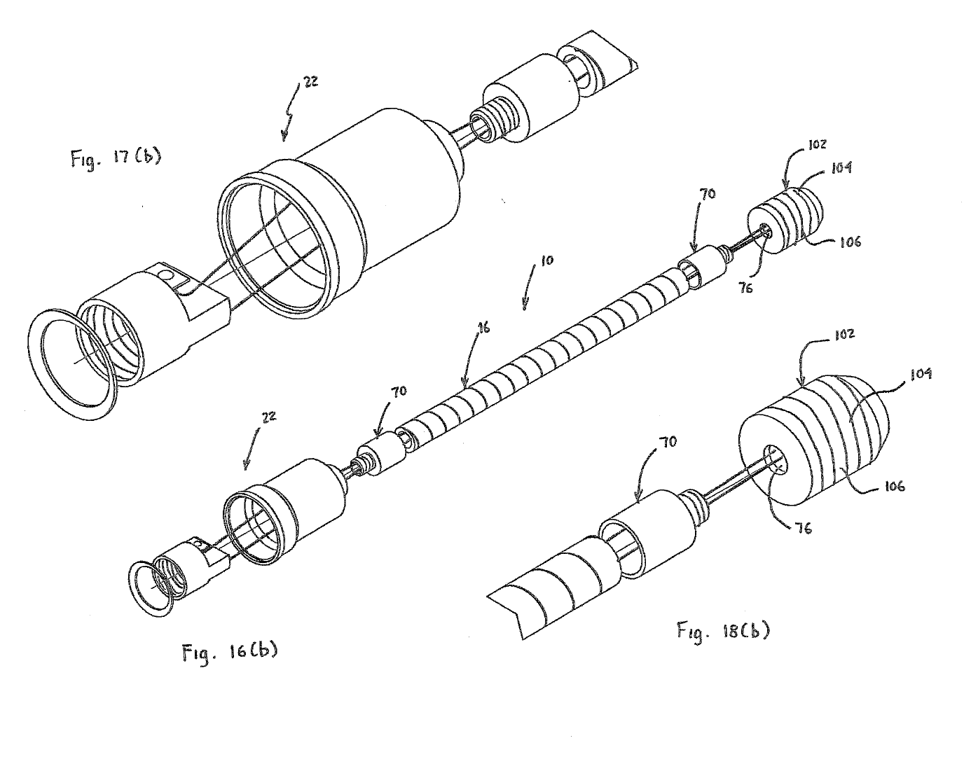

A further preferred and non-limiting embodiment of a socket extension apparatus 10 is illustrated in FIGS. 16-18. In this embodiment, the socket member 22 is positioned at the second end 20 of extension member 16 using a nipple member 70. However, and in order to connect the socket extension apparatus 10 to the power source P, a socket projection member 102 is used. This socket projection member 102 includes a socket projection 104 having a threaded outer surface 106. In this manner, the socket projection member 102 is engageable with a socket recess SR of a socket S (as is known in the art). Again, other projections and configurations of this socket projection member 102 can be used to allow for engagement with a variety of different types of sockets S and light bulbs LB. Accordingly, the socket projection member 102 is not limited to the single socket projection 104 used in connecting with a traditional incandescent light bulb socket S. Further, in this embodiment, the socket projection member 102 also includes a nipple recess 76 for threaded engagement with the projection 74 of a nipple member 70 positioned at the first end 18 of extension member 16.

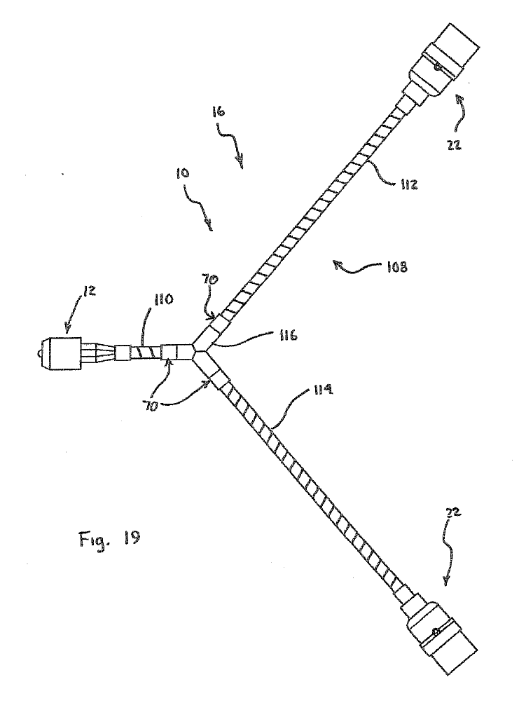

In a further preferred and non-limiting embodiment, and as illustrated in FIGS. 19-23, the socket extension apparatus 10 may include a branched extension arrangement. In particular, the extension member 16 is in the form of a plurality of branch members 108. For example, in the illustrated embodiment, the extension member 16 is in the form of a primary branch 110, a first branch 112, and a second branch 114. Both the first branch 112 and the second branch 114 are connected to the primary branch 110 through a splitter connection 116. The wiring 56 extends through a hollow interior of the splitter connection 116 and out towards the ends of each of the first branch 112 and second branch 114. Further, the splitter connection 116 includes three nipple recesses 76 (which may include internal threads) at each end of the splitter connection 116, such that a nipple member 70 can be used at an end of each branch 110, 112, 114 to attach the branch 110, 112, 114 to a respective arm of the splitter connection 116. Of course, and other permanent, semi-permanent, or removable connection is envisioned.

In this embodiment, a socket member 22 is positioned at the end of each of the first branch 112 and the second branch 114, and operates as described hereinabove. In addition, and in this embodiment, a plug member 48 is located at the end of the primary branch 110, and can be used alone in connection with an electrical outlet O or together with a socket adapter 12 (as shown). Accordingly, this embodiment illustrates further beneficial extension characteristics and flexible functionality.

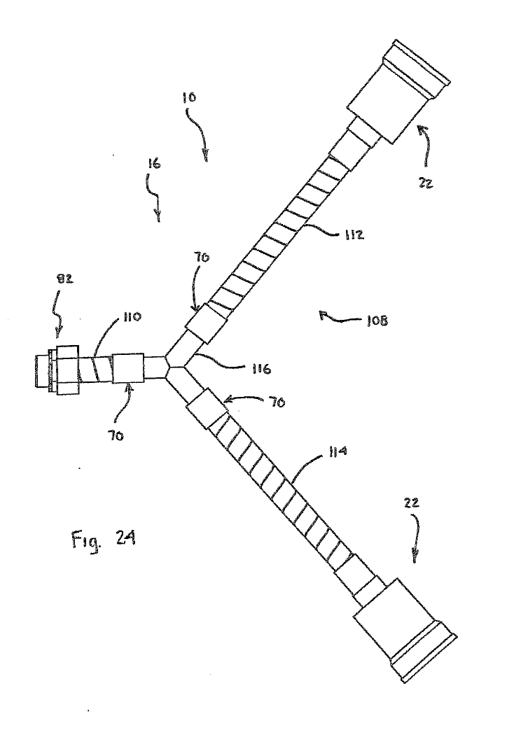

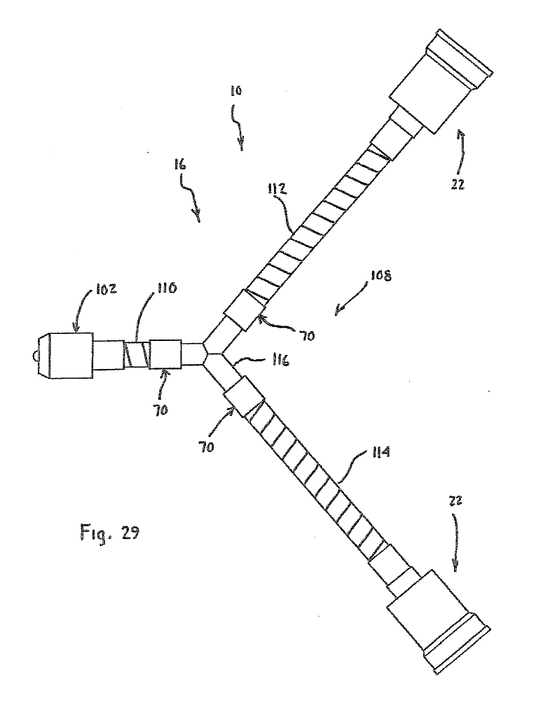

A further preferred and non-limiting embodiment of the socket extension apparatus 10 is illustrated in FIGS. 24-28. This embodiment is similar to the embodiment of FIGS. 19-23, and includes branch members 108, with a socket member 22 at the ends of a first branch 112 and second branch 114. However, the first end of the primary branch 110 includes the above-discussed power connection arrangement 82. Accordingly, this embodiment allows the socket extension apparatus 10 to be directly wired into an electrical box B. Similarly, and in the preferred embodiment of FIGS. 29-33, the socket extension apparatus 10 includes the first branch 112 and second branch 114, each with a socket member 22 at the end thereof. However, in this embodiment, the above-discussed socket projection member 102 is positioned at the first end of the primary branch 110. This socket projection member 102 operates as described above.

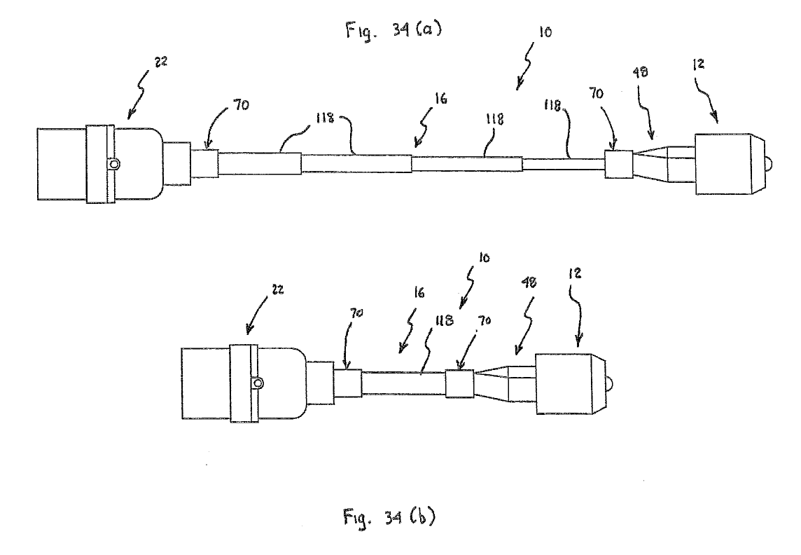

In a still further preferred and non-limiting embodiment, the extension member 16 is configured to telescope in at least one direction. For example, as illustrated, multiple, nesting sleeves 118 can be used for extending and collapsing the extension member 16. FIG. 34(a) illustrates the socket extension apparatus 10 of this embodiment in an extended state, while FIG. 34(b) illustrates the socket extension apparatus 10 of this embodiment in a collapsed state. The remaining connections and arrangements at the first end 18 and/or second end 20 of the extension member 16 may be formed or configured as discussed above.

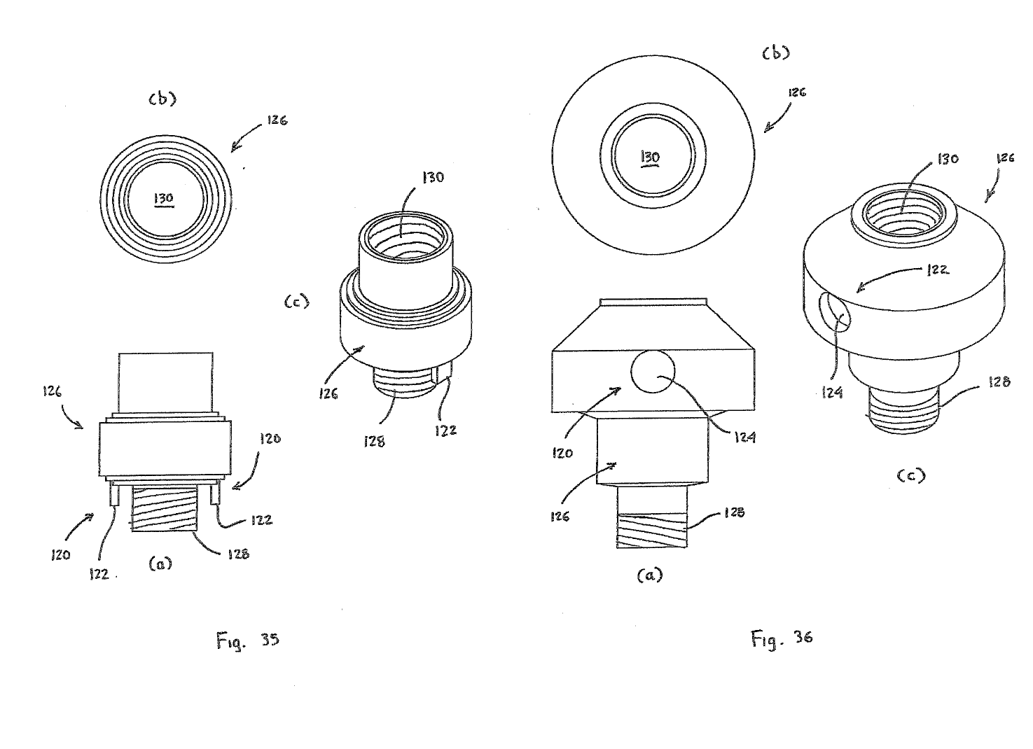

As shown in FIG. 35, and in another preferred and non-limiting embodiment, one or more sensors 120 can be utilized in connection with the socket extension apparatus 10. As illustrated, these sensors 120 can be incorporated into a socket extender 126 having a socket projection 128 at one end and a socket recess 130 at the other end. This socket extender 126 can be used in connection with the socket member 22 of the socket extension apparatus 10, as, for example, an add-on or separately purchasable component. However, these sensors 120 may also be engaged with or integrated with the socket member 22, or any of the remaining portions of the socket extension apparatus 10 (or socket adapter 12, plug adapter 14, etc.). In the embodiment of FIG. 35, the sensors 120 are touch sensors 122 that are configured to activate (or deactivate) the flow of power to the light bulb LB that is positioned in the socket extender 126 engaged with the socket member 22. In the preferred and non-limiting embodiment of FIG. 36, the sensor is a motion sensor 124 that allows the socket extender 126 to be selectively energized based upon the presence of sensed motion (via the socket member 22).

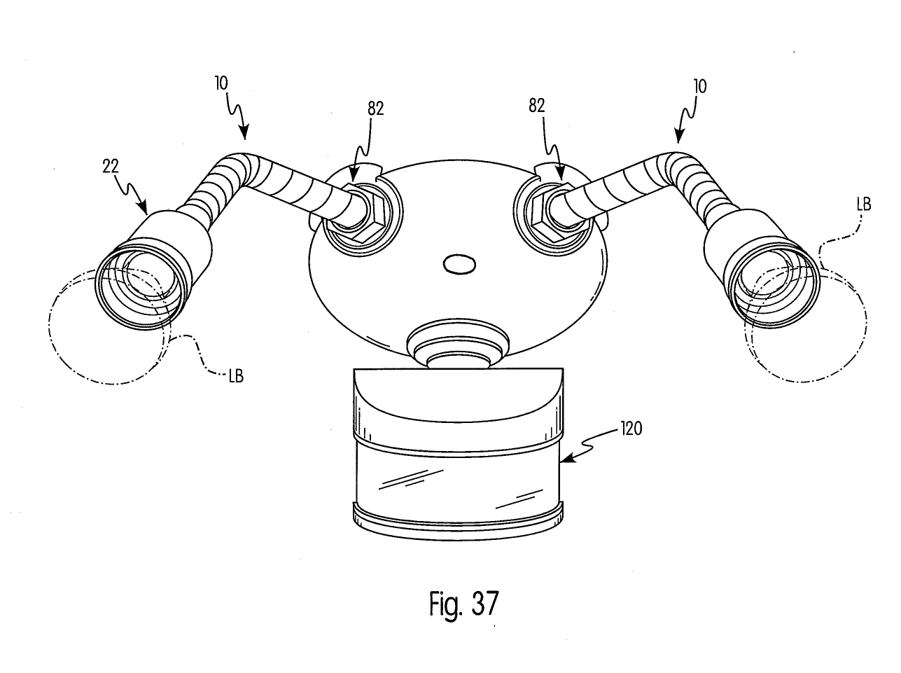

In the preferred and non-limiting embodiment of FIG. 37, it is demonstrated that the sensor 120, e.g., the motion sensor 124, can be integrated into other portions of the socket extension apparatus 10, or even in connection with the power source P, such as the electrical box B, the electrical outlet O, the socket S, etc. In addition, the socket extension apparatus 10 may include some timer mechanism for selectively permitting the socket member 22 to be energized or de-energized at or during selected periods. In addition, the sensor 120 may be in the form of a solar panel or other sensor configured to sense the presence or absence of external light, thereby permitting the socket member 22 (or socket extender 126) to be energized or de-energized based upon this sensed condition. Any such control aspect of the light bulb LB (or socket member 22) is envisioned within the context of the present invention.

As discussed above, the plug member 48 and/or the plug adapter 14 may include a three-prong or two-prong male plug for insertion into any standard household three-prong or two-prong electrical outlet O (or receptacle). This allows the user to simply plug the socket extension apparatus 10 into any open receptacle, switch the socket extension apparatus 10 “on” and have a configurable light source. In particular, the user may adjust the direction of the light bulb LB by simply bending the extension member 16 into a direction of the user's choosing. Further, when using a three-prong arrangement, such as with the plug member 48, the ground prong 54 also provides a stabilizing ability to the socket extension apparatus 10. In particular, and since the socket extension apparatus 10 extends from the (normally) vertical surface of the electrical outlet O, the lower-positioned ground prong 54 yields extra stability and strength to the socket extension apparatus 10 during manipulation, and in preventing accidental dislodgment from the electrical outlet O.

The use of the socket adapter 12 allows the socket extension apparatus 10 to be sold in a variety of configurable forms, and this socket adapter 12 allows the user to convert any standard light arrangement into a directional lighting system. In particular, socket extension apparatus 10 (with an installed light bulb LB) can be threadedly inserted into an existing light socket S. Further, if installed in a switch-operated socket S, the switch must be turned on in order to provide the appropriate power to the device.

The extension member 16 can be manufactured from a variety of materials. For example, in the preferred embodiment discussed above, the extension member 16 is in the form of a ribbed tube 64. This ribbed tube 64 may be coated with a corrosion-resisting compound, and can be colored and/or sized in any desirable manner. As discussed above, and when using the power connection arrangement 82, the socket extension apparatus 10 may be directly wired into any electrical mounting device, such as the electrical box B. Of course, this electrical box B may also be an electrical ground sleeve with an appropriate fitting.

When used outdoors, it is often preferable to use the gasket 98, and, in the power connection arrangement 82, the flexible conduit 84. In addition, the connection between the components of the power connection arrangement 82 can take a variety of forms, and the washer 96 may be in the form of a locking ring or the like. Further, the use of the threaded conduit 86 and flexible conduit 84 is augmented through the use of the nut 92 for compressing the connection.

As set forth hereinabove, the socket extension apparatus 10, socket adapter 12, and plug adapter 14 are assembled from multiple, discrete components. In some embodiment, these components are permanently or semi-permanently and directly or indirectly secured together. For example, the socket adapter 12 or plug adapter 14 may be secured to the extension member 16 through a threaded connection. However, it is envisioned that the various components may be secured or attached together through any attachment means, such as welding, adhesive attachment, bonding attachment, or the like. Further, the various components of the socket extension apparatus 10, socket adapter 12, and plug adapter 14 may be formed integrally in a manufacturing process.

Overall, the present invention provides a socket extension apparatus 10, socket adapter 12, and plug adapter 14 that provide unique functionality and beneficial characteristics in the area of lighting arrangements and systems. In particular, the user is provided with a uniquely configurable device to allow increased flexibility in lighting specified areas.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A socket extension apparatus, comprising:
an elongate extension member having a first end and a second end; and
at least one socket member in operational communication with the second end of the extension member and in direct or indirect electrical communication with an external power source through the first end of the extension member, the at least one socket member comprising at least one socket recess configured to removably engage at least one light bulb.

2. The socket extension apparatus of claim 1, wherein the elongate extension member is bendable in at least one direction to a bent position.

3. The socket extension apparatus of claim 2, wherein the elongate extension member is configured to remain in the bent position until further manipulated.

4. The socket extension apparatus of claim 1, wherein the elongate extension member is configured to telescope in at least one direction.

5. The socket extension apparatus of claim 1, further comprising a power connection arrangement in direct or indirect operational engagement with the first end of the extension member for receiving and transferring power to the at least one socket member.

6. The socket extension apparatus of claim 5, wherein the power connection arrangement comprises a plug member having a body and at least two prongs extending therefrom.

7. The socket extension apparatus of claim 6, wherein the plug member includes three prongs extending from the body.

8. The socket extension apparatus of claim 6, wherein the power connection arrangement further comprises a socket adapter having a first end and a second end, wherein the first end comprises a socket projection configured for removable attachment with a socket recess, and wherein the second end comprises at least two slots configured to receive the at least two prongs of the plug member.

9. The socket extension apparatus of claim 5, wherein the power connection arrangement comprises a socket projection member having a socket projection configured for removable attachment with a socket recess.

10. The socket extension apparatus of claim 9, wherein the power connection arrangement further comprises a plug adapter having a first end and a second end, wherein the first end comprises at least two prongs extending therefrom, and wherein the second end comprises a socket recess configured to removably engage the socket projection.

11. The socket extension apparatus of claim 5, wherein the power connection arrangement comprises at least one attachment structure configured to attach the first end of the extension member to an electrical outlet arrangement.

12. The socket extension apparatus of claim 1, further comprising at least one wire extending through an internal space of the extension member and in electrical communication with the socket member on the second end of the extension member.

13. The socket extension apparatus of claim 1, wherein the second end of the extension member comprises a plurality of branch members, each having a distal end and a respective socket member in operational communication with the distal end.

14. The socket extension apparatus of claim 1, further comprising a motion sensor configured to permit the light bulb to be selectively energized by the socket member.

15. The socket extension apparatus of claim 1, further comprising a touch-activated sensor configured to selectively permit the at least one socket member to be energized or de-energized.

16. The socket extension apparatus of claim 1, wherein the external power source is at least one of the following: an electrical box, an electrical outlet, a light bulb socket, or any combination thereof.

17. The socket extension apparatus of claim 1, further comprising a reflective member attachable to at least one of the extension member and the at least one socket member and including an internal surface for reflecting light emitted from a light bulb attached to the at least one socket recess.

18. The socket extension apparatus of claim 1, further comprising a guard member attachable to at least one of the extension member and the at least one socket member and configured to at least partially surround a light bulb attached to the at least one socket recess.

19. The socket extension apparatus of claim 1, further comprising an actuatable switch configured to selectively permit the at least one socket member to be energized or de-energized.

20. A socket adapter, comprising:
a body with a first end and a second end;
a socket projection at the first end of the body and configured for removable attachment with a socket recess;
two aligned slots at the second end of the body configured to receive two power prongs of a three-prong plug member; and
a lower slot at the second end of the body configured to receive a ground prong of the three-prong plug member.

21. A plug adapter, comprising:
a body with a first end and a second end;
at least two prongs at the first end of the body configured for insertion into at least two slots of an electrical outlet; and
a socket recess at the second end of the body configured to removably engage at least one light bulb.
